(19) United States
(12) Patent Application Publication
(10) Pub. No.: US 2009/0274021 A1
(43) Pub. Date: Nov. 5, 2009

(54) Optical Information Recording/Reproducing Method and Optical Information Recording/Reproducing Device

(76) Inventor: Kenji Narumi, Osaka (JP)

Correspondence Address: WENDEROTH, LIND & PONACK L.L.P., 1030 15th Street, N.W., Suite 400 East, Washington, DC, 20005-1503, US

(21) Appl. No.: 11/887,570

(22) PCT Filed: Dec. 20, 2005
(86) PCT No.: PCT/JP2005/023348

§ 371 Date: Sep. 28, 2007

(30) Foreign Application Priority Data
Mar. 30, 2005 (JP) 2005-097396

(51) Int. Cl. G11B 7/00

(52) U.S. Cl. 369/44.28; G9B/7

(57) ABSTRACT

An acceleration pulse waveform adjusting circuit (10) and a deceleration pulse waveform adjusting circuit (11) change the amplitude of a track jump pulse in accordance to linear velocity, so as to stably carry out track jump over a wide range of linear velocities. In case tracking gain is to be changed according to the linear velocity, the acceleration pulse waveform adjusting circuit (10) and the deceleration pulse waveform adjusting circuit (11) make the amplitude of acceleration pulse larger and the amplitude of deceleration pulse smaller, respectively, when the tracking gain is high, so as to stably carry out track jump operation with the given tracking gain.

### TECHNICAL FIELD

The present invention relates to an optical information recording/reproducing method and an optical information recording/reproducing device for an optical information recording medium on or from which information is optically recorded or reproduced, and particularly to a method of controlling track jump.

### BACKGROUND ART

Optical disk, optical card, optical tape and the like have been developed as optical information recording media, wherein information (data) is optically recorded. Among these, the optical disk is greatly valued for the capability thereof to store a large amount of information with high density and allow the information to be reproduced.

The optical disk generally has groove called the track formed on the surface in a spiral configuration. In the case of read-only optical disk, a row of pits may play the role of the track, instead of the groove.

Laser beam is focused by an object lens to form a spot on the disk, so as to record or reproduce information as the track is traced. The operation of controlling the tracing motion without deviating from the track is called the tracking control.

Tracking control is carried out by converting the diffraction pattern of the laser beam reflected on the disk into an electrical signal. The electrical signal is called the tracking error signal. Tracking error signal having a non-zero value indicates that the laser spot is displaced from the center of the track. The deviation of the tracking error signal from zero is roughly proportional to the displacement of the spot.

Tracking control is carried out by controlling the optical head actuator so as to minimize the deviation of the tracking error signal from zero. When tracking control is carried out ideally with the laser spot precisely tracing the center of the track, the tracking error signal remains always zero. In practice, however, deviation of the tracking error signal from zero level may have a definite value even when tracking is under control, which is called the residual difference.

The residual difference is caused by an off-center displacement of the optical disk, surface fluctuation, microscopic deformation of the track configuration or the like, which results in the disability of tracking control to follow the mechanical deformation of the optical disk. When the residual difference becomes too large, it becomes difficult to carry out the tracking control, and the desired track intended for recording or reproducing information may not be properly traced. As a result, the laser spot may jump to an unintended track, or it may become impossible to carry out the tracking control (which is called the off-track error).

On the other hand, in the meantime, recording or reproducing information on or from the optical disk may require it to repetitively trace the same track, in such cases as keeping a particular frame of a movie picture displayed still, the so-called still reproduction. Since the track of the optical disk is formed in spiral configuration as described previously, the laser spot may be displaced off the proper track toward the inner or outer side while continuing to trace the track. Therefore, it is necessary to jump the laser spot from the outer track to the inner track (or vice versa) once every full turn, which is called still jump, in order to keep tracing the same track.

In order to achieve random access, one of the advantageous functions of the optical disk, it is necessary to move the laser spot to the desired track at will. This operation of moving the laser spot is called the seek operation. The seek operation is generally carried out by moving the optical head over the carriage for coarse adjustment, and continuously jumping the track while checking the addresses of the positions on the optical disk for fine adjustment. The track jump for this purpose is called the seek jump. In either case, track jump is an indispensable, important operation for the optical disk.

FIG. 15 shows the constitution of a recording/reproducing device of the related art. FIGS. 16A through 16c show signal waveforms for explaining the track jump operation in the recording/reproducing device of the related art. FIG. 16A shows a tracking error signal 7 prior to the track jump operation, FIG. 16B shows a track jump signal 14 and FIG. 16C shows the tracking error signal 7 when the track jump operation is done.

Track jump is controlled as a track jump control circuit 1502, which is included in the constitution shown in FIG. 15, generates the track jump pulse shown in FIG. 16B. To jump the laser spot from a track to an inner track, for example, an acceleration pulse generating circuit 12 generates an acceleration pulse 301 so as to accelerate an actuator toward the inside. Then a deceleration pulse generating circuit 13 generates deceleration pulse 302 at the time when the laser spot passes a mid point between the track which has been traced and the next track located inside, so as to stop the movement of the actuator at the center of the track located inside. This completes the track jump operation (refer to, for example, Japanese Examined Patent Publication (Kokoku) No. 52-50098). The acceleration pulse 301 and the deceleration pulse 302 will hereafter be called collectively as track jump pulse 303.

Further, in order to increase the transmission rate during recoding or reproduction of information, it has been vigorously studied to increase the rotational speed of the optical disk so as to increase the linear velocity and, at the same time, increase the clock signal frequency for the recording signal and/or the reproduction signal (which is called the enhanced double speed). Particularly in recent years, as the demand for enhanced double speed has been increasing, the recording/reproducing device is required to operate over a wider range of linear velocities from a low linear velocity to a high linear velocity.

However, in case the linear velocity is increased with the recording/reproducing device of the related art, there has been such a problem that the track jump operation may result in a failure which has not been experienced at a low linear velocity, as will be described below in more detail.

In order to increase the linear velocity, rotational speed of the optical disk must be increased and therefore the actuator follows the mechanical deformation of the optical disk with higher acceleration. The control signal for the following operation of the actuator also has higher frequency component. However, there are limitations to the frequencies and gain available in driving the actuator. Increasing the frequency range and gain used in the tracking control too much may result in over-current flowing in the actuator coil which may eventually burn out.

Thus, there has been such a problem that, when the linear velocity is increased with an actuator of definite performance, the residual difference of tracking error signal becomes larger and the track jump operation under this condition results in off-track failure.

In the case of a low linear velocity, residual difference is sufficiently small as shown in FIG. 16A and normal track jump operation is achieved as shown in FIG. 16C when a track jump pulse as shown FIG. 16B is generated. At a higher linear velocity, however, residual difference of a significant magnitude may occur as shown in FIG. 17A. When track jump operation is carried out by generating such a track jump pulse 303 as shown in FIG. 17B at this point, there have been such cases as a larger number of tracks than desired are jumped over due to large residual difference when an acceleration pulse 301 is generated as shown in FIG. 17C, or off-track failure occurs due to insufficient deceleration of the actuator by the deceleration pulse 302, thus resulting in disability of recording or reproduction of the desired information at a high linear velocity.

For recording or reproducing information at a high linear velocity, such a practice is employed as tracking gain is switched to a higher level in a range within which the actuator can be driven, so as to suppress the residual difference in order to improve the stability of tracking control. With this method, however, it is difficult to carry out track jump despite the increased gain when the linear velocity is high. Therefore, proper track jump operation cannot be made as shown in the waveform of tracking error signal of FIG. 18C even when the track jump pulse 303 as shown FIG. 18B is generated under the condition of the tracking error signal as shown FIG. 18A.

### DISCLOSURE OF THE INVENTION

The present invention solves the problems of the related art described above, and has an object of providing an optical information recording/reproducing method and an optical information recording/reproducing device which are capable of stably recording or reproduce information by stably carrying out track jump at high linear velocities or over a wide range of linear velocities.

A first optical information recording/reproducing method according to one aspect of the present invention is a method of recording or reproducing information on or from the optical information recording medium by irradiating the optical information recording medium, driven at one of at least two different linear velocities, with a laser beam, the method comprising an error signal detecting step in which the tracking error signal is generated from laser beam reflected on or transmitted through the medium, a tracking control step in which tracking operation is controlled by using the tracking error signal and a track jump control step where the track jump pulse including acceleration pulse and/or deceleration pulse is generated so as to cause the laser spot to jump to the track on or from which information is to be recorded or reproduced, wherein the track jump control step includes a step of changing the waveform of track jump pulse in accordance to the linear velocity.

According to this method, since an optimum track jump pulse can be set in accordance to the linear velocity, it is made possible to carry out track jump operation stably over a wide range of linear velocities so as to record and reproduce information stably.

An optical information recording/reproducing method according to another aspect of the present invention is a method of recording or reproducing information on or from the optical information recording medium by irradiating the optical information recording medium with a laser beam, the method comprising the error signal detecting step in which the tracking error signal is generated from the laser beam reflected on or transmitted through the medium, the tracking control step in which tracking operation is controlled by using the tracking error signal, a residual difference of tracking detecting step in which residual difference of the tracking error signal is detected during the tracking control operation and the track jump control step where the track jump pulse including acceleration pulse and/or deceleration pulse is generated so as to cause the laser spot to jump to the track on or from which information is to be recorded or reproduced, wherein the track jump control step includes a step of changing the waveform of track jump pulse in accordance to the residual difference of the tracking error signal.

According to this method, since an optimum track jump pulse can be set in accordance to the residual difference, it is made possible to carry out track jump operation stably over a wide range of linear velocities so as to record and reproduce information stably.

An optical information recording/reproducing method according to further another aspect of the present invention is a method of recording or reproducing information on or from the optical information recording medium by irradiating the optical information recording medium with a laser beam, the method comprising the error signal detecting step in which the tracking error signal is generated from the laser beam reflected on or transmitted through the medium, the tracking control step in which tracking operation is controlled by using the tracking error signal, the residual difference of tracking detecting step in which the amount of residual difference of the tracking error signal is detected during the tracking control operation and the track jump control step where the track jump pulse including acceleration pulse and/or deceleration pulse is generated so as to cause the laser spot to jump to the track on or from which information is to be recorded or reproduced, wherein the track jump control step includes a step of generating the track jump pulse at a position where the residual difference of the tracking error signal becomes smaller than a predetermined value in one round of the track.

According to this method, it is made possible to carry out track jump operation stably over a wide range of linear velocities without adjusting the waveform of the track jump pulse, so as to record and reproduce information stably.

An optical information recording/reproducing method according to further another aspect of the present invention is a method of recording or reproducing information on or from the optical information recording medium by irradiating the optical information recording medium with a laser beam, the method comprising the error signal detecting step in which the tracking error signal is generated from the laser beam reflected on or transmitted through the medium, the tracking control step in which tracking operation is controlled by using the tracking error signal, the residual difference of tracking detecting step in which the amount of residual difference of the tracking error signal is detected during the tracking control operation and the track jump control step in which the track jump pulse including acceleration pulse and/or deceleration pulse is generated so as to cause the laser spot to jump to the track on or from which information is to be recorded or reproduced, wherein the track jump control step includes a step of carrying out track jump after changing the linear velocity of the optical information recording medium in accordance to the residual difference of the tracking error signal.

According to this method, it is made possible to carry out track jump operation stably over a wide range of linear velocities without adjusting the waveform of track jump pulse or the position of track jump, so as to record and reproduce information stably.

An optical information recording/reproducing device according to further another aspect of the present invention is a device for recording or reproducing information on and/or from the optical information recording medium by irradiating the optical information recording medium, driven at one of at least two different linear velocities, with a laser beam, the device comprising an error signal detecting circuit which generates the tracking error signal from the laser beam reflected on or transmitted through the medium, a tracking control circuit which controls the tracking operation by using the tracking error signal and a track jump control circuit which generates the track jump pulse including acceleration pulse and/or deceleration pulse so as to cause the laser spot to jump to the track on or from which information is to be recorded or played back, wherein the track jump control circuit changes the waveform of the track jump pulse in accordance to the linear velocity.

This device is capable of setting an optimum track jump pulse in accordance to the linear velocity, and therefore it is made possible to carry out track jump operation stably over a wide range of linear velocities so as to record and reproduce information stably.

An optical information recording/reproducing device according to further another aspect of the present invention is a device for recording or reproducing information on and/or from the optical information recording medium by irradiating the optical information recording medium with a laser beam, the device comprising the error signal detecting circuit which generates the tracking error signal from the laser beam reflected on or transmitted through the medium, the tracking control circuit which controls the tracking operation by using the tracking error signal, the residual difference of tracking detecting circuit which detects the residual difference of the tracking error signal during the track control operation and the track jump control circuit which generates the track jump pulse including acceleration pulse and/or deceleration pulse so as to cause the laser spot to jump to the track on or from which information is to be recorded or reproduced, wherein the track jump control circuit changes the waveform of the track jump pulse in accordance to the residual difference of the tracking error signal.

Since this device is capable of setting an optimum track jump pulse in accordance to the residual difference, it is made possible to carry out track jump operation stably over a wide range of linear velocities so as to record and reproduce information stably.

An optical information recording/reproducing device according to further another aspect of the present invention is a device for recording and/or reproducing information on and/or from the optical information recording medium by irradiating the optical information recording medium with a laser beam, the device comprising the error signal detecting circuit which generates the tracking error signal from the laser beam reflected on or transmitted through the medium, the tracking control circuit which controls the tracking operation by using the tracking error signal, the residual difference of tracking detecting circuit which detects the amount of residual difference of the tracking error signal during the track control operation and the track jump control circuit which generates the track jump pulse including acceleration pulse and/or deceleration pulse so as to cause the laser spot to jump to the track on or from which information is to be recorded or reproduced, wherein the track jump control circuit generates the track jump pulse at a position where the residual difference of the tracking error signal becomes smaller than a predetermined value in one round of the track.

This device is capable of carrying out track jump stably over a wide range of linear velocities without adjusting the waveform of the track jump pulse so as to record and reproduce information stably.

A optical information recording/reproducing device according to further another aspect of the present invention is a device which records and/or plays back information on and/or from the optical information recording medium by irradiating the optical information recording medium with a laser beam, the device comprising the error signal detecting circuit which generates the tracking error signal from the laser beam reflected on or transmitted through the medium, the tracking control circuit which controls the tracking operation by using the tracking error signal, the residual difference of tracking detecting circuit which detects the amount of residual difference of the tracking error signal during the track control operation, the track jump control circuit which generates the track jump pulse including acceleration pulse and/or deceleration pulse so as to cause the laser spot to jump to the track on or from which information is to be recorded or played back, and a system control circuit that changes the linear velocity of the optical information recording medium in accordance to the amount of residual difference of the tracking error signal, wherein the track jump control circuit carries out track jump after the linear velocity of the optical information recording medium has been changed in accordance to the amount of residual difference of the tracking error signal.

This device is capable of carrying out track jump stably without adjusting the waveform of the track jump pulse or the position of track jumping so as to record and reproduce information stably.

### BRIEF DESCRIPTION OF THE DRAWINGS

FIG. 1 is a block diagram showing the constitution of a recording/reproducing device according to first embodiment of the present invention.

FIG. 2 is a flow chart explanatory of the operation of the recording/reproducing device according to the first embodiment.

FIGS. 3A through 3C are signal waveform diagrams showing an example of track jump operation according to the first embodiment.

FIG. 4 is a block diagram showing the constitution of a recording/reproducing device according to second embodiment of the present invention.

FIG. 5 is a flow chart explanatory of the operation of adjusting the track jump of the recording/reproducing device according to the second embodiment.

FIG. 6 is a block diagram showing the constitution of a recording/reproducing device according to third embodiment of the present invention.

FIG. 7 is a flow chart explanatory of the operation of the recording/reproducing device according to the third embodiment.

FIG. 8 is a flow chart explanatory of the operation of adjusting the track jump of the recording/reproducing device according to the third embodiment.

FIG. 9 is a block diagram showing the constitution of a recording/reproducing device according to fourth embodiment of the present invention.

FIG. 10 is a flow chart explanatory of the operation of adjusting the track jump of the recording/reproducing device according to the fourth embodiment.

FIGS. 11A through 11C are signal waveform diagrams showing an example of track jump operation according to the fourth embodiment.

FIG. 12 is a block diagram showing the constitution of a recording/reproducing device according to fifth embodiment of the present invention.

FIG. 13 is a flow chart explanatory of the operation of adjusting the rotational speed of the recording/reproducing device according to the fifth embodiment.

FIGS. 14A through 14D are signal waveform diagrams showing an example of track jump operation according to the fifth embodiment.

FIG. 15 is a block diagram showing the constitution of a recording/reproducing device of the related art.

FIGS. 16A through 16C are signal waveform diagrams showing an example of track jump operation with the recording/reproducing device of the related art.

FIGS. 17A through 17C are signal waveform diagrams showing another example of track jump operation with the recording/reproducing device of the related art.

FIGS. 18A through 18C are signal waveform diagrams showing another example of track jump operation with the recording/reproducing device of the related art.

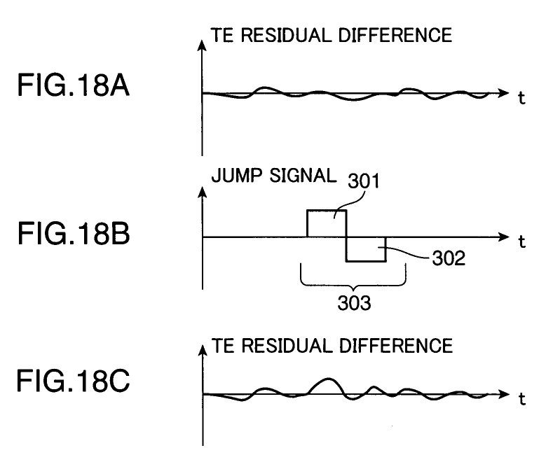

### BEST MODE FOR CARRYING OUT THE INVENTION

The present invention will now be described in further detail by way of embodiments.

### First Embodiment

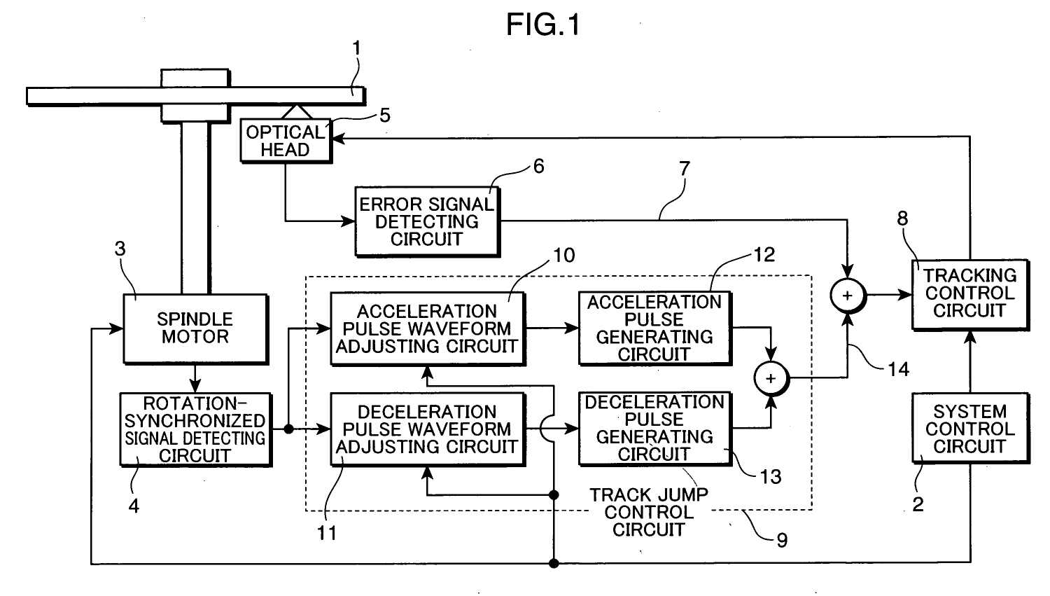

First, track jump operation with an optical information recording/reproducing method according to first embodiment of the present invention will be described by making reference to FIGS. 1 through 3C. FIG. 1 is a block diagram schematically showing the constitution of the recording/reproducing device according to the first embodiment of the present invention.

In FIG. 1, reference numeral 1 denotes an optical disk holding information (data) recorded thereon or to be reproduced therefrom, 2 denotes a system control circuit that controls the entire recording/reproducing device, 3 denotes a spindle motor which drives the optical disk 1 to rotate, 4 denotes rotation-synchronized signal detecting circuit which detects a signal synchronized with the rotation of the spindle motor 3 and 5 denotes an optical head which irradiates the optical disk 1 with a laser beam.

Reference numeral 6 denotes an error signal detecting circuit which detects a tracking error signal according to reflected light from the optical disk 1, 7 denotes the tracking error signal, 14 denotes a track jump signal used in track jump operation, 8 denotes a tracking control circuit which controls the tracking operation according to the tracking error signal 7 and the track jump signal 14.

Reference numeral 9 denotes a track jump control circuit comprising an acceleration pulse waveform adjusting circuit 10, a deceleration pulse waveform adjusting circuit 11, an acceleration pulse generating circuit 12 and a deceleration pulse generating circuit 13.

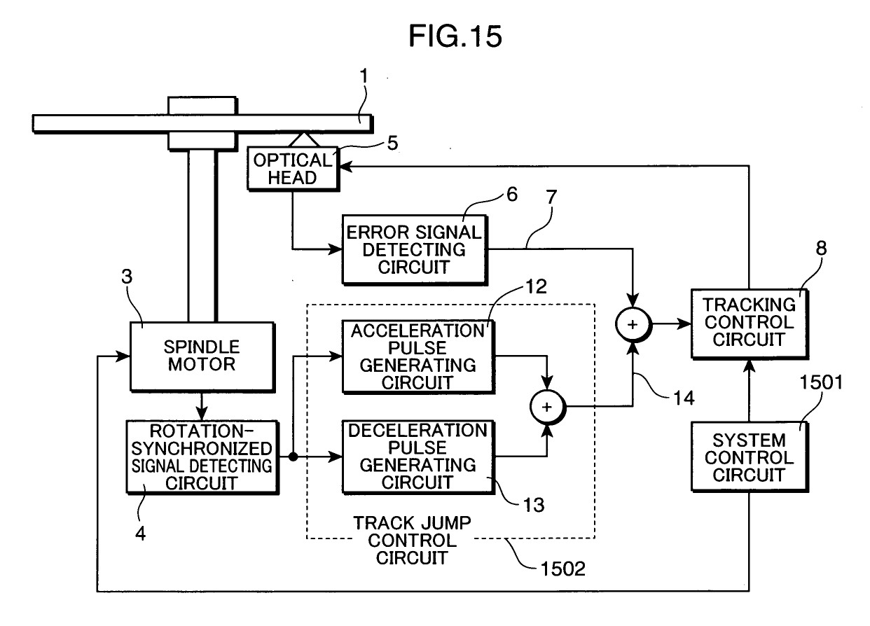

The recording/reproducing device shown in FIG. 1 is different from the recording/reproducing device of the related art shown in FIG. 15 in the constitution thereof, in that the acceleration pulse waveform adjusting circuit 10 and the deceleration pulse waveform adjusting circuit 11 are provided in the track jump control circuit 9.

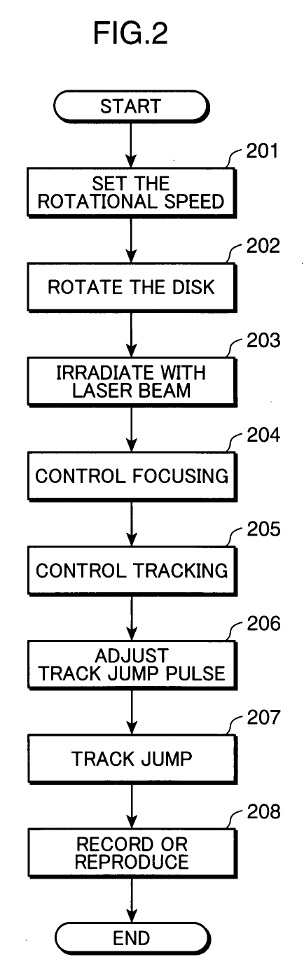

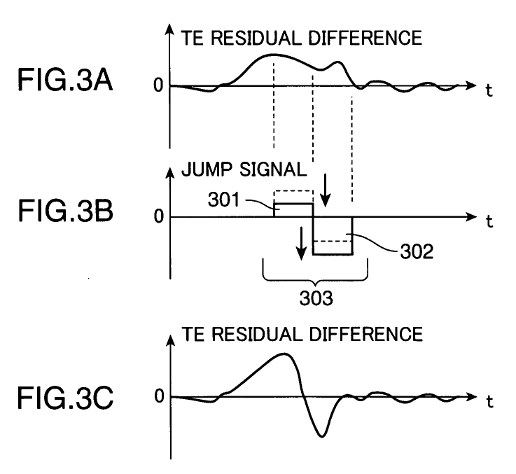

Next, the operation of the recording/reproducing device of this embodiment will be described with reference to the flow chart of FIG. 2 and the signal waveform diagrams of FIGS. 3A through 3C.

FIG. 2 is a flow chart showing the operation according to this embodiment. FIGS. 3A through 3C are signal waveform diagrams showing the operation of reproducing or recording information by setting the linear velocity higher according to this embodiment. FIG. 3A shows the tracking error signal 7 prior to carrying out the track jump operation, FIG. 3B shows the track jump signal 14 and FIG. 3C shows the tracking error signal 7 when the track jump operation is done.

To reproduce or record information, first, the system control circuit 2 sets the rotational speed of the spindle motor 3 in a rotational speed setting step 201 (hereinafter denoted simply as 201) and the optical disk 1 is driven to rotate at a predetermined linear velocity (a high linear velocity in this embodiment) in a disk rotation step 202. At this time, the rotation-synchronized signal detecting circuit 4 detects a signal synchronized with the rotation of the spindle motor 3. Then in a laser irradiation step 203, a laser drive circuit (not shown) directs a laser beam to the optical disk 1, and an actuator of the optical head 5 is controlled so that the laser beam is focused in a focus control step 204.

Next, in a tracking control step 205, the actuator of the optical head 5 is controlled in the direction of tracking so as to carry out the tracking operation according to the tracking error signal 7 received from the error signal detecting circuit 6. Since the optical disk 1 is rotating at a high linear velocity, the tracking error signal has a value significantly different from zero (i.e. has a large residual difference) as shown in FIG. 3A.

Then in a track jump pulse adjusting step 206, the acceleration pulse waveform adjusting circuit 10 and the deceleration pulse waveform adjusting circuit 11 adjust the waveforms of the acceleration pulse 301 and the deceleration pulse 302 generated by the acceleration pulse generating circuit 12 and the deceleration pulse generating circuit 13, respectively, in accordance to commands from the system control circuit 2. The acceleration pulse generating circuit 12 and the deceleration pulse generating circuit 13 generate an acceleration pulse 301 and a deceleration pulse 302, respectively. The acceleration pulse 301 and the deceleration pulse 302 are added up so as to generate the track jump signal 14 that includes the track jump pulse 303, while the track jump signal 14 and the tracking error signal 7 are added up and sent to the tracking control circuit 8.

Then in a track jump step 207, the system control circuit 2 controls the tracking control circuit 8 so as to cause the optical head 5 to carry out still jump or seek jump at the desired timing. In the case of still jump, a jump pulse is generated once every one turn of the optical disk according to the signal from the rotation-synchronized signal detecting circuit 4. This does not apply to the case of seek jump.

Last, information is reproduced or recorded from or in the predetermined track of the optical disk 1 in a record/reproduction step 208, to complete the record/reproduction operation.

The operation of the recording/reproducing device described above is different from the operation of the recording/reproducing device of the related art in that waveform of the track jump pulse is made different between the case of low linear velocity and the case of high linear velocity. According to this embodiment, when information is reproduced or recorded with a high linear velocity, amplitude of the acceleration pulse 301 is set smaller and amplitude of the deceleration pulse 302 is set larger than in the case of lower linear velocity.

The tracking error signal shown in FIG. 3A shows residual difference of a large positive value at the timing of generating the acceleration pulse 301. This means that the laser spot is located at a position a little displaced toward the adjacent track to which the laser spot is to be jumped and, at the same time, that the laser spot is likely to drift toward the adjacent track even when track jump operation is not carried out, namely the tracking control is unstable. However, since the amplitude of the acceleration pulse 301 is made smaller as shown in FIG. 3B, the tracking error signal (FIG. 3C) during track jump operation does not show excessively large residual difference even at the instant of generating the acceleration pulse 301. As a result, velocity of the actuator can be increased by a value appropriate for jumping over one track, without jumping over too many tracks or causing off-track failure.

The tracking error signal shows residual difference of a large positive value also at the timing of generating the deceleration pulse. This means that the laser spot is located at a position which is displaced a little toward the adjacent track to which the laser spot is to be jumped, namely the tracking control is unstable, similarly to the case of generating the acceleration pulse. In this embodiment, amplitude of the deceleration pulse 302 is made larger as shown in FIG. 3B, with the increase in the amplitude being negative, opposite to the polarity (positive) of the residual difference of the tracking error signal.

By increasing the amplitude of the deceleration pulse 302, it is made possible to slow down the actuator more effectively so as to prevent the laser spot from jumping over too may tracks. As a result, movement of the actuator can be stopped at the adjacent track with sufficient stability, so as to carry out track jump operation stably as indicated by the tracking error signal shown in FIG. 3C.

The high linear velocity and the low linear velocity described above may be defined as follows. In case the recording/reproducing device is capable of operating in a range of linear velocities from 20 to 60 m/s, for example, a threshold may be set at 40 m/s so that the zone below 40 m/s is called the low linear velocity range and the zone equal to or more than 40 m/s is called the high linear velocity range. In this case, waveform of the track jump pulse for the low linear velocity range and waveform of the track jump pulse for the high linear velocity range are memorized in advance in the acceleration pulse generating circuit 12 and the deceleration pulse generating circuit 13, respectively. Thus the amplitude of the acceleration pulse 301 can be adjusted to be smaller than in the case of lower linear velocity and the amplitude of the deceleration pulse 302 can be adjusted to be larger than in the case of lower linear velocity when information is reproduced or recorded in the high linear velocity range, as the acceleration pulse waveform adjusting circuit 10 and the deceleration pulse waveform adjusting circuit 11 control the acceleration pulse generating circuit 12 and the deceleration pulse generating circuit 13, respectively.

The method of adjusting the track jump pulse is not limited to the example described above. Various modifications can be made such as using two or more thresholds which separate three or more ranges of linear velocities with waveform of the track jump pulse appropriate for each of these ranges of linear velocities being memorized so as to adjust the waveform of the track jump pulse for each range of linear velocities, or changing the amplitude and/or pulse width of the track jump pulse in proportion to the linear velocity.

Important point of this embodiment is to make the waveform of the track jump pulse 303 different between the cases of high linear velocity and low linear velocity as shown in FIG. 3B. This makes it possible to carry out stable track jump over a wide range of linear velocities, so as to achieve the special effect of enabling stable recording and reproducing.

While the amplitude of the acceleration pulse is adjusted to be smaller and the amplitude of the deceleration pulse is adjusted to be larger in this embodiment, the track jump operation may also be stabilized by making adjustment in different senses depending on the state of residual difference of the tracking error signal. Alternatively, amplitudes and/or pulse widths of the acceleration pulse and the deceleration pulse may be adjusted individually such as decreasing the amplitude of the acceleration pulse only without changing the amplitude of the deceleration pulse, or increasing the amplitude of the deceleration pulse only without changing the amplitude of the acceleration pulse.

Next, the effect of the first embodiment will be described by way of the results of experiment.

A polycarbonate resin sheet measuring 120 mm in diameter and mm in thickness was used for the substrate of the optical disk 1 shown in FIG. 1. The substrate was pre-formatted with phase pits formed in a control track region.

The control track region contained information, indicating the linear velocity accepted by the disk for recording thereon, recorded as an identifier. In this Example, the disk was designed to receive recording with linear velocities ranging from 8.2 m/s to 65.6 m/s which is 8 times the lowest linear velocity.

Guide groove for recording was formed in data region of the substrate. The guide groove was formed from the inside toward the periphery with a pitch of 1.4 μm, in a spiral configuration. The data region may be divided into sectors with the phase pits indicating address information formed between adjacent sectors.

Four layers of protective film, recording film, protective film and reflector film were formed on the substrate by sputtering, with a protective substrate bonded thereon. The protective film was formed from ZnS—SiO₂, the recording film was formed from GeSbTe and the reflector film was formed from Al.

The optical disk was irradiated with a laser beam of wavelength 660 nm from the optical head 5 having output power of 1 mW and object lens of NA value 0.6, while the disk was rotating at the lowest linear velocity of 8.2 m/s.

After irradiation with the laser beam, the tracking error signal 7 was monitored while effecting focus control and disabling tracking control. The tracking error signal 7 had quasi sinusoidal waveform with zero-to-peak amplitude of 4.5 V.

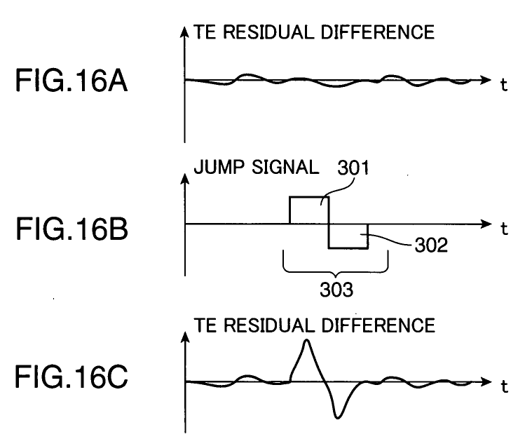

Then tracking operation was carried out under the control of the tracking control circuit 8, while monitoring the tracking error signal 7. The tracking error signal 7 changed as shown in FIG. 16A while the disk made a full turn, indicating that stable tracking operation was achieved at linear velocity of 8.2 m/s. Maximum value of residual difference was 0.3 V in terms of zero-to-peak amplitude.

Then the track jump control circuit 9 generated the track jump signal once every turn of the optical disk 1, and the waveform of the track jump pulse was adjusted so as to make still jump to an inner track. This resulted in stable track jump operation with the waveform shown in FIG. 16C. Monitoring of the acceleration pulse 301 and the deceleration pulse 302 showed that the acceleration pulse 301 had zero-to-peak amplitude of 1.8 V and pulse width of 200 μs, and the deceleration pulse 302 had zero-to-peak amplitude of 1.8 V (with the polarity opposite to that of the acceleration pulse) and pulse width of 200 μs.

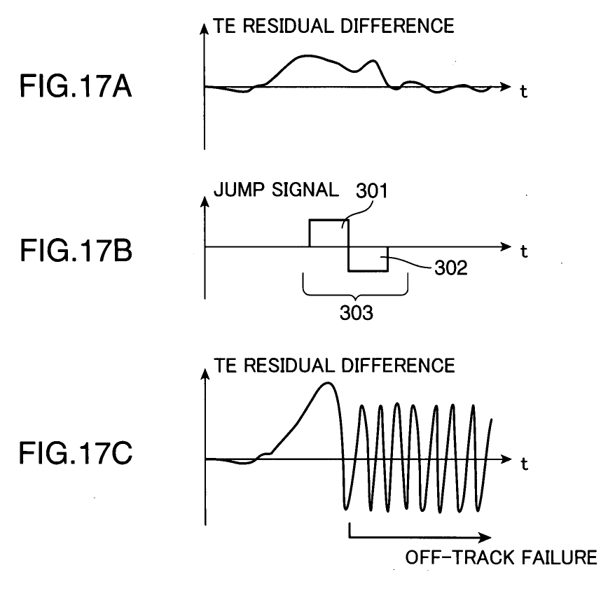

Then rotational speed of the optical disk 1 was increased so as to set the linear velocity to 65.6 m/s. With the still jump function disabled, the tracking error signal 7 was monitored, and the residual difference showed a local deviation from the zero level as shown in FIG. 17A. Maximum residual difference measured around the time of generating the waveform of track jump pulse was 3.9V in terms of zero-to-peak amplitude. This means that the laser spot traces the track at a position displaced from the center of the track toward the inside at the time of making track jump.

When it was attempted to make still jump by generating waveform of track jump pulse with the linear velocity adjusted to 8.2 m/s, off-track failure occurred as shown in FIG. 17C. Then after putting the tracking control into effect at the linear velocity to 65.6 m/s and adjusting the amplitude of the acceleration pulse to 1.2 V and the amplitude of the deceleration pulse to 2.4 V, still jump was made. This made it possible to carry out track jump stably with such a waveform as shown in FIG. 3C.

This is supposedly because decreasing the amplitude of the acceleration pulse directed toward the inside and increasing the amplitude of the deceleration pulse directed toward the outside suppressed the tendency of the laser spot, that was tracing at a position displaced toward the inside, to make excessive jumping toward the inside.

### Second Embodiment

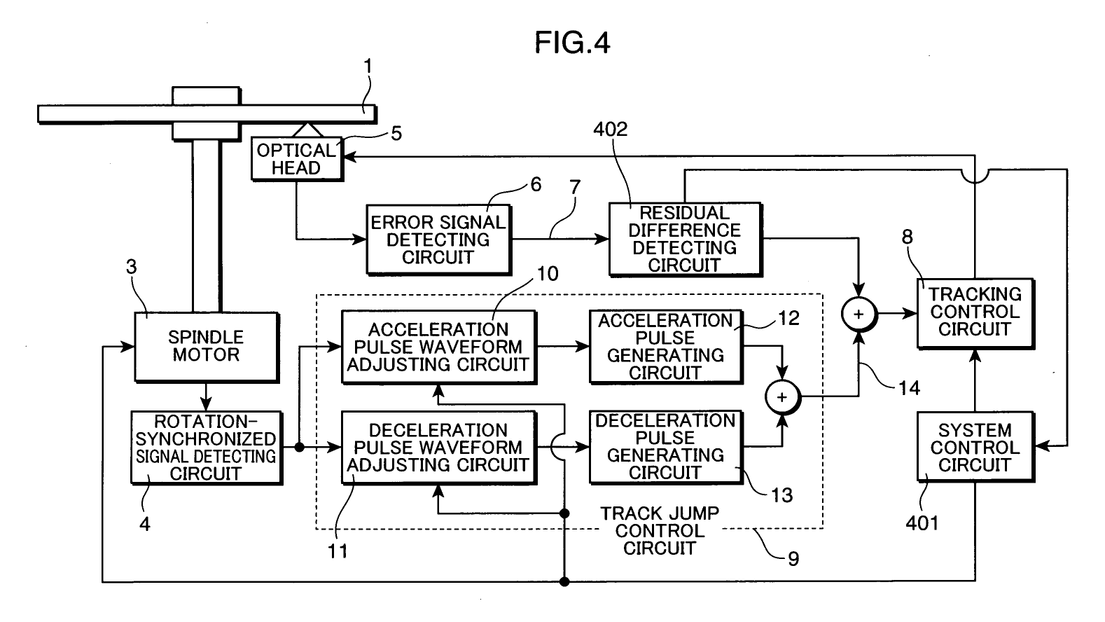

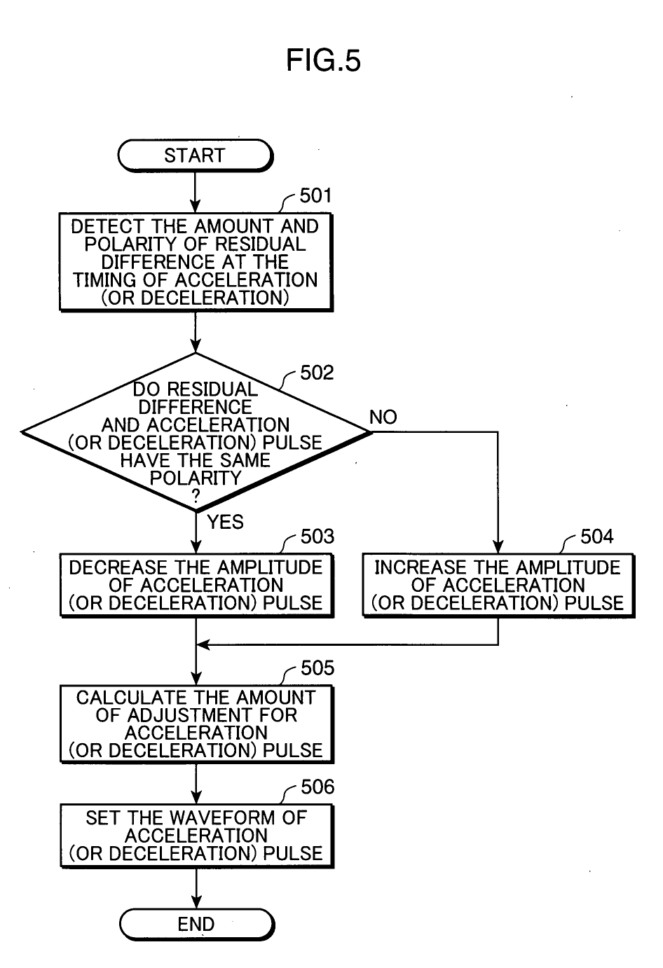

Constitution and operation of second embodiment of the present invention will now be described by making reference to the constitution diagram of FIG. 4 and the flow chart of FIG. 5. Operation of this embodiment can be illustrated by the same signal diagrams as FIG. 3.

FIG. 4 shows the constitution of this embodiment. This embodiment is different from the first embodiment in that a residual difference detecting circuit 402 is provided for detecting and measuring the polarity and amount of residual difference of the tracking error signal, and the system control circuit 401 adjusts the waveform of the track jump pulse by using the acceleration pulse waveform adjusting circuit 10 and the deceleration pulse waveform adjusting circuit 11.

FIG. 5 is a flow chart for explaining in detail the track jump adjusting process, which corresponds to the track jump adjustment step 206 of the first embodiment, among the operations of the second embodiment. Operations other than the track jump adjusting step 206 are the same as those of the first embodiment, and will not be described in detail.

The track jump adjusting process among the operations of this embodiment will now be described with reference to FIG. 5. First, in a residual difference and polarity detecting step 501, a residual difference detecting circuit 402 detects the amount and polarity of the residual difference of the tracking error signal at the timing (for example, the timing when the acceleration pulse rises and the deceleration pulse falls) of generating the track jump pulse (namely the acceleration pulse and the deceleration pulse), and outputs the result to the system control circuit 401.

Subsequent steps include the same processes for the acceleration pulse and the deceleration pulse. Description here will first deal with a case of adjusting the waveform of the acceleration pulse.

In a polarity judging step 502, the system control circuit determines whether the acceleration pulse and the residual difference have the same polarity or not. When the acceleration pulse and the residual difference have the same polarity, it means that the laser spot is displaced from the center of the current track and is located at a position a little displaced toward the adjacent track to which the laser spot is to be jumped. Accordingly, the system control circuit 401 determines to decrease the amplitude of the acceleration pulse in pulse amplitude decreasing step 503. This suppresses the laser spot from jumping over the adjacent track of destination during track jump operation.

When the acceleration pulse and the residual difference have different polarities, it means that the laser spot is located at a position a little displaced toward the side opposite to the adjacent track to which the laser spot is to be jumped. Accordingly, the system control circuit 401 determines to increase the amplitude of the acceleration pulse in the pulse amplitude increasing step 504. This prevents such a failure that the laser spot cannot reach the adjacent track of destination during track jump operation.

Then in an adjustment amount computing step 505, the system control circuit 401 calculates how much the acceleration pulse should be adjusted in accordance to the amount of residual difference. The easiest and preferable method for this process is to change the amplitude of the acceleration pulse in proportion to the amount of residual difference at the time of generating the acceleration pulse.

Last, in a pulse waveform setting step 506, the system control circuit 401 commands the acceleration pulse adjusting circuit 10 to determine the amplitude of the acceleration pulse according to the amount of adjustment that has been calculated.

A case of adjusting the waveform of the deceleration pulse will now be described with reference to the flow chart of FIG. 5.

In the polarity judging step 502, the system control circuit 401 determines whether the deceleration pulse and the residual difference have the same polarity or not. When the deceleration pulse and the residual difference have the same polarity, it means that the laser spot is located at a position displaced a little from the center of the current track in a direction opposite to the adjacent track to which the laser spot is to be jumped. In this case, the system control circuit 401 determines to decrease the amplitude of the deceleration pulse in the pulse amplitude decreasing step 503. This prevents such a failure that the laser spot cannot reach the adjacent track of destination during track jump operation.

When the deceleration pulse and the residual difference have different polarities, it means that the laser spot is located at a position displaced a little from the center of the current track toward the adjacent track to which the laser spot is to be jumped. In this case, the system control circuit 401 determines to increase the amplitude of the deceleration pulse in the pulse width increasing step 504. This suppresses the laser spot from jumping over the adjacent track of destination during track jump operation.

Then in the adjustment amount computing step 505, the system control circuit 401 calculates how much the deceleration pulse should be adjusted in accordance to the amount of residual difference. The easiest and preferable method for this process is to change the amplitude of the deceleration pulse in proportion to the amount of the residual difference at the time of generating the deceleration pulse.

Last, in the pulse waveform setting step 506, the system control circuit 401 commands the deceleration pulse adjusting circuit 11 to determine the amplitude of the deceleration pulse according to the amount of adjustment that has been calculated.

In this embodiment, as described above, residual difference of the tracking error signal is detected at the timing of making track jump, and it is determined whether to increase or decrease the track jump pulse (namely the acceleration pulse and the deceleration pulse) according to the polarity of the residual difference. This makes it possible to make stable track jump over a wide range of linear velocities, so as to achieve special effect of enabling stable recording and reproducing.

In this embodiment, amplitude of the track jump pulse is changed in proportion to the residual difference. However, the present invention is not limited to this scheme. Various modifications can be made such as using one or more thresholds which separate two or more ranges of residual difference with waveform of track jump pulse appropriate for each of these ranges of residual difference being memorized so as to change the amplitude and/or pulse width of the track jump pulse for each of these ranges of residual difference.

### Third Embodiment

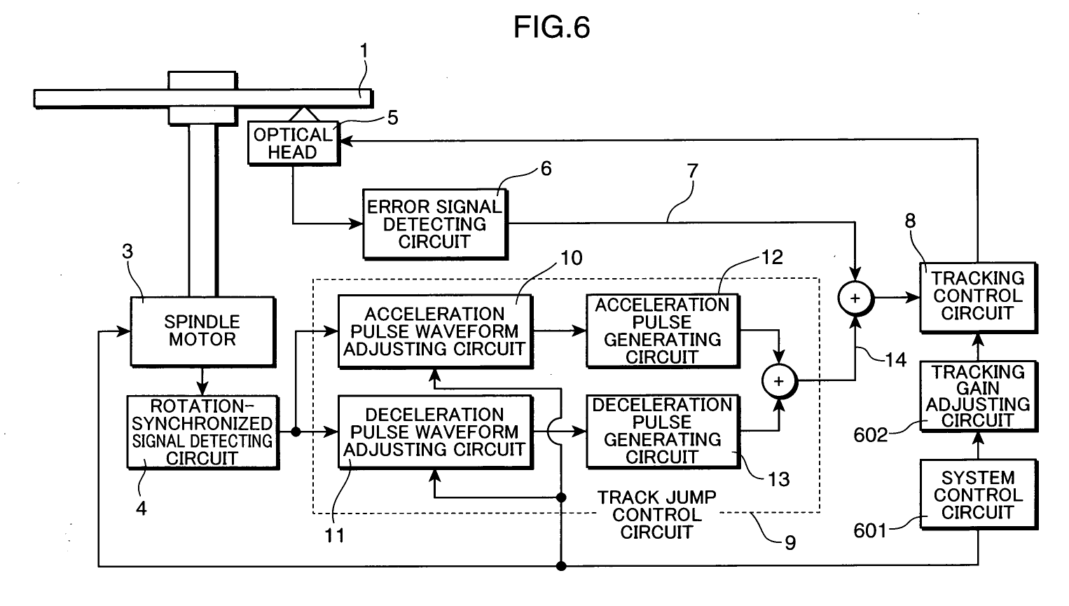

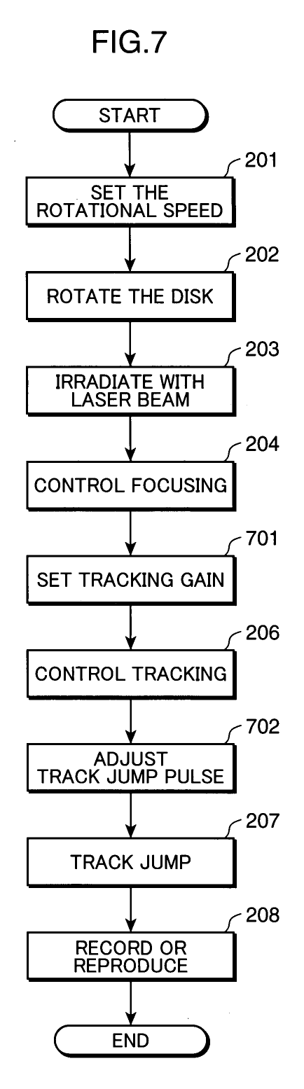

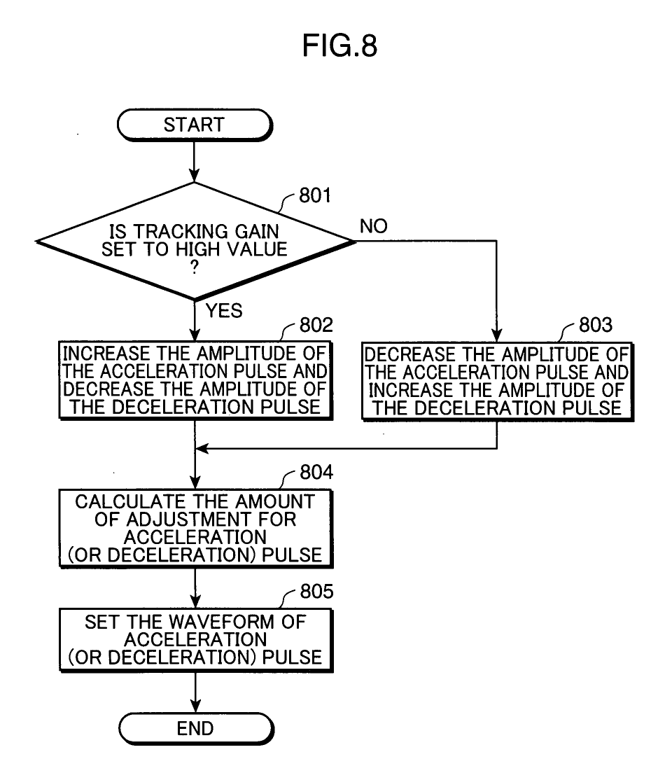

Constitution and operation of third embodiment of the present invention will now be described by making reference to the constitution diagram of FIG. 6 and the flow charts of FIG. 7 and FIG. 8.

FIG. 6 shows the constitution of this embodiment. This embodiment is different from the first embodiment in that a tracking gain adjusting circuit 602 is provided for adjusting the gain of tracking control, and that the system control circuit 601 adjusts the tracking gain of the tracking control circuit 8 by using the tracking gain adjusting circuit 602.

FIG. 7 is a flow chart showing the operation of this embodiment. One of differences of this embodiment from the first embodiment is that a tracking gain setting step 701 is provided for setting the tracking gain. In this step, the system control circuit 601 adjusts the gain of tracking control by using the tracking gain adjusting circuit 602 in accordance to the linear velocity. The larger the linear velocity, the larger the residual difference of the tracking error signal generally becomes, and therefore the gain is increased when the linear velocity is high, so as to suppress the residual difference.

Another difference of this embodiment from the first embodiment is the process carried out in the track jump pulse adjusting step 702, which will be described below with reference to FIG. 8.

FIG. 8 is a flow chart explanatory of the process carried out in the track jump pulse adjusting step according to this embodiment. First, the system control circuit 601 determines in the tracking gain judging step 801 whether the tracking gain has been set to a high value or not.

When the tracking gain is high (i.e. the linear velocity is high), the tracking control circuit 8 applies tight control to the actuator so that the laser spot is less likely to deviate from the center of track. When track jump operation is carried out under this condition, the effect of the acceleration pulse to cause the laser spot to jump to the adjacent track becomes weak, while the effect of the deceleration pulse to brake the laser spot movement becomes stronger.

Accordingly, in this case, the system control circuit 601 determines in the acceleration pulse/deceleration pulse adjusting step 802 to increase the amplitude of the acceleration pulse and decrease the amplitude of the deceleration pulse. Then in the adjustment amount computing step 804, the system control circuit 601 calculates the amount of adjustment of the acceleration pulse and the deceleration pulse in accordance to the gain. Next in the pulse waveform setting step 805, the system control circuit 601 controls the acceleration pulse waveform adjusting circuit 10 and the deceleration pulse waveform adjusting circuit 11 so as to generate waveforms of the acceleration pulse and the deceleration pulse with the calculated amount of adjustment. Thus, proper track jump operation can be carried out even when the tracking gain is high.

When the tracking gain is low (i.e. the linear velocity is low), the tracking control circuit 8 applies weak control to the actuator so that the laser spot may deviate relatively easily from the center of track. When track jump operation is carried out under this condition, the effect of the acceleration pulse to cause the laser spot to jump to the adjacent track becomes stronger, while the effect of the deceleration pulse to brake the laser spot movement becomes weaker.

In this case, the system control circuit 601 determines in the acceleration pulse/deceleration pulse adjusting step 802 to decrease the amplitude of the acceleration pulse and increase the amplitude of the deceleration pulse. Processes in the adjustment amount computing step 804 and the pulse waveform setting step 805 are similar to those of the case of high tracking gain. Thus proper track jump operation can be carried out even when the tracking gain is low.

In this embodiment, as described above, waveform of the track jump pulse is adjusted according to the tracking gain. This enables it to carry out track jump operation stably even when the tracking gain is changed in accordance to the linear velocity.

In this embodiment, amplitudes of the acceleration pulse and the deceleration pulse are changed in proportion to the gain, although the present invention is not limited to the example described above. Various modifications can be made such as using one or more predetermined thresholds which separate two or more ranges of gain, with the waveform of track jump pulse appropriate for each of these ranges of gain being memorized so as to adjust the amplitude and/or pulse width of the track jump pulse separately for each range of gain.

In case the recording/reproducing device is capable of operating in a range of linear velocities from 20 to 60 m/s, for example, and a threshold is set at 40 m/s so as to use a low gain for the zone below 40 m/s and a high gain (for example, a gain 5 dB higher than the low gain) for the zone equal to or more than 40 m/s, then waveform of the track jump pulse for the low gain and waveform of the track jump pulse for the high gain are memorized in advance in the acceleration pulse generating circuit 12 and the deceleration pulse generating circuit 13, and the amplitude of the acceleration pulse can be made larger than in the case of low gain and the amplitude of the deceleration pulse can be made smaller than in the case of low gain when information is reproduced or recorded by using high gain, as the acceleration pulse waveform adjusting circuit 10 and the deceleration pulse waveform adjusting circuit 11 control the acceleration pulse generating circuit 12 and the deceleration pulse generating circuit 13, respectively.

### Fourth Embodiment

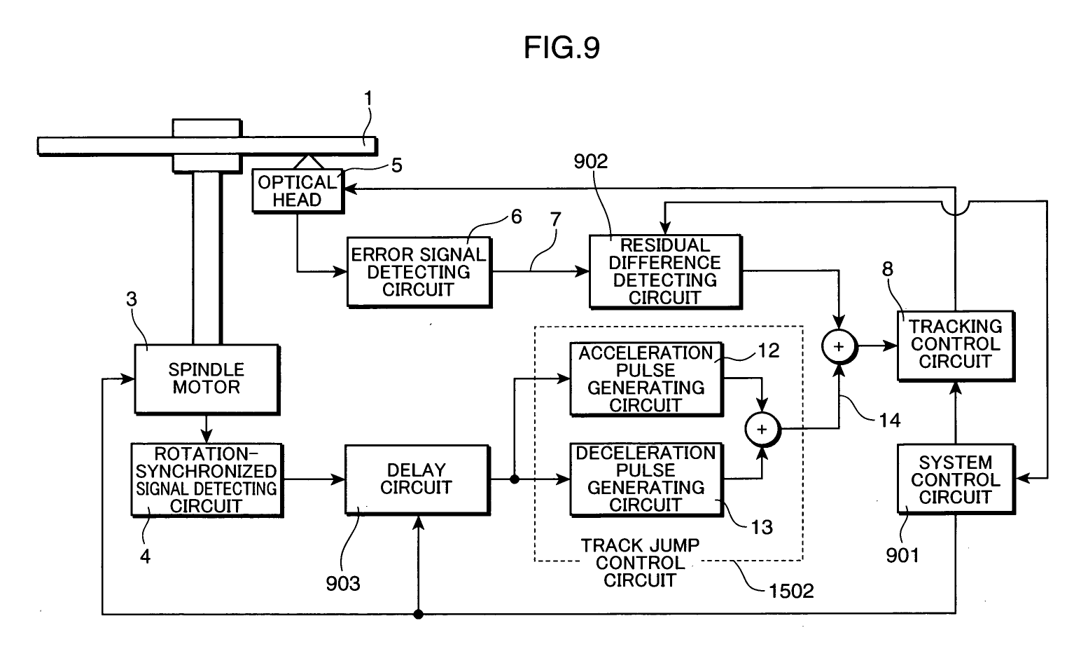

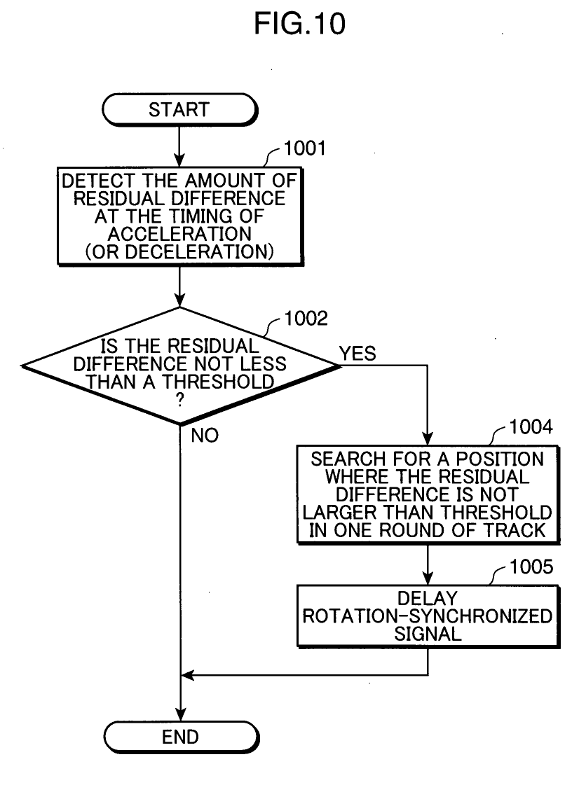

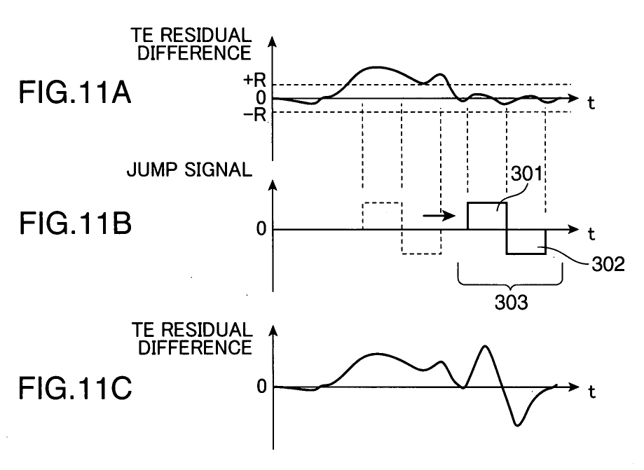

Constitution and operation of fourth embodiment of the present invention will now be described by making reference to the constitution diagram of FIG. 9, flow chart of FIG. 10 and signal waveform diagrams of FIGS. 11A through 11C.

FIG. 9 shows the constitution of this embodiment. First difference of this embodiment from the first embodiment is that a residual difference detecting circuit 902 is provided for detecting the residual difference of the tracking error signal so that the system control circuit 901 controls a delay circuit 903 so as to control the timing of generating the track jump pulse in accordance to the residual difference which has been detected.

Second difference of this embodiment from the first embodiment is that the track jump control circuit 1502 comprises only acceleration pulse generating circuit 12 and the deceleration pulse generating circuit 13 similarly to the related art. Third point of difference is that the delay circuit 903 is provided behind the rotation-synchronized signal detecting circuit 4, so that the system control circuit 901 controls the amount of delay.

FIG. 10 shows the details of the process in the track jump pulse adjusting step in this embodiment. Processes other than the track jump pulse adjusting step are similar to those of the first embodiment.

FIGS. 11A through 11C show the signal waveforms explanatory of the operation of this embodiment. FIG. 11A shows the tracking error signal 7 prior to making the track jump operation, FIG. 11B shows the track jump signal 14 and FIG. 11C shows the tracking error signal 7 when the track jump operation is done.

The processes in the track jump pulse adjusting step will now be described. First, in a residual difference detecting step 1001, the residual difference detecting circuit 902 detects the amount of residual difference at the timing of generating the acceleration pulse (or the deceleration pulse) and outputs the result to the system control circuit 901. In a residual difference judging step 1002, the system control circuit 901 determines whether the detected residual difference is not less than a certain value.

In the case of such a tracking error signal as shown in FIG. 11A, absolute value of the residual difference is larger than a predetermined value (R) at the timing of making track jump (refer to waveform of track jump pulse shown by the dashed line in FIG. 11B). In this case, in the residual difference searching step 1004, the system control circuit 901 makes inquiry of the residual difference on the residual difference detecting circuit 902 so as to find out a position where the absolute value of the residual difference is less than R in one round of the track. In the synchronization signal delaying step 1005, the system control circuit 901 controls the delay circuit 903 so as to delay the timing of the synchronization signal till the position where the absolute value of the residual difference is less than R is reached.

The tracking error signal shown in FIG. 11A indicates that absolute value of the residual difference is less than R at a timing delayed from the timing of making track jump (refer to waveform of track jump pulse indicated by solid line in FIG. 11B). Therefore, it is made possible to make track jump stably as shown in FIG. 11C without adjusting the waveform of the track jump pulse, in case the timing of track jump is delayed by the delay circuit 903 as shown by the solid line in FIG. 11B.

If the residual difference detected in the residual difference judging step 1002 is less than a certain value, jumping operation can be carried out stably without delaying the timing of track jump by the delay circuit 903.

In this embodiment, as described above, a position where the absolute value of the residual difference of the tracking error signal is less than R in one round of the track is searched and track jump is carried out at this point. Therefore, it is made possible to make track jump stably over a wide range of linear velocities without adjusting the waveform of the track jump pulse.

In this embodiment, the system control circuit 901 makes inquiry of the residual difference on the residual difference detecting circuit 902 so as to find out a position where the absolute value of the residual difference is less than R. However, the present invention is not limited to this embodiment and various modifications can be made such as providing a predetermined memory in the system control circuit, memorizing the residual difference in one track detected by the residual difference detecting circuit 902, and finding out a position where the absolute value of residual difference is less than R by making reference to the value of residual difference stored in the memory.

### Fifth Embodiment

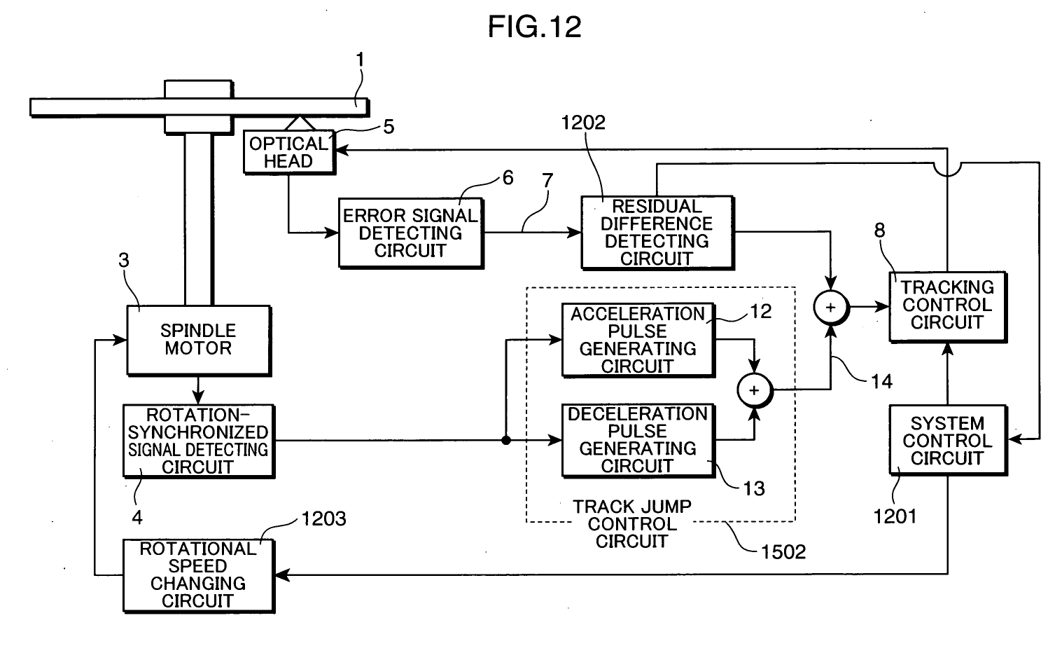

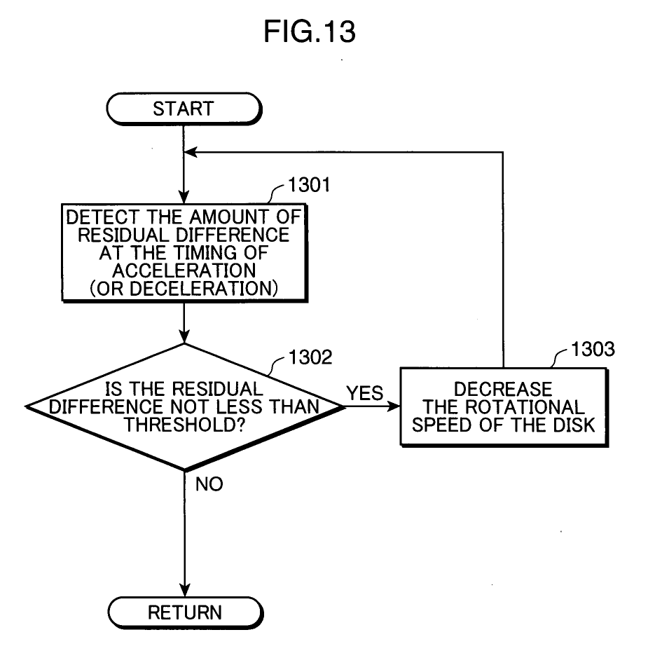

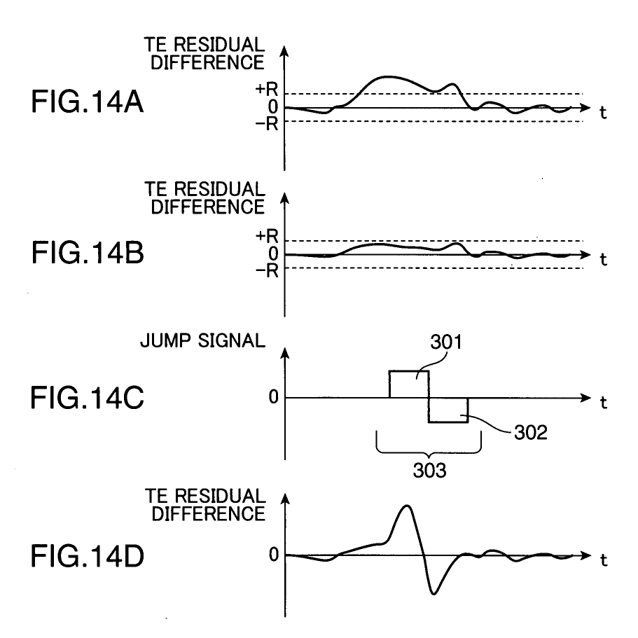

Constitution and operation of fifth embodiment of the present invention will now be described by making reference to the constitution diagram of FIG. 12, flow chart of FIG. 13 and signal waveform diagrams of FIGS. 14A through 14D.

FIG. 12 shows the constitution of this embodiment. First difference of this embodiment from the first embodiment is that the residual difference detecting circuit 1202 is provided for detecting the residual difference of the tracking error signal so that the system control circuit 1201 controls the rotational speed of the spindle motor in accordance to the residual difference which has been detected.

Second difference of this embodiment from the first embodiment is that the track jump control circuit 1502 comprises only the acceleration pulse generating circuit 12 and the deceleration pulse generating circuit 13 similarly to the case of related art. Third point of difference is that a rotational speed changing circuit 1203 is provided, so that the system control circuit 1201 can change the rotational speed of the spindle motor.

FIG. 13 shows details of the process in the rotational speed adjusting step in this embodiment. The rotational speed adjusting step replaces the track jump pulse adjusting step 206 of the first embodiment, and the other processes are similar to those of the first embodiment.

FIGS. 14A through 14D show the signal waveforms explanatory of the operation of this embodiment. FIG. 14A shows the tracking error signal 7 prior to making the track jump operation, FIG. 14B shows the tracking error signal 7 after decreasing the linear velocity and before making the track jump operation, FIG. 14C shows the track jump signal 14 and FIG. 14D shows the tracking error signal 7 when the track jump operation is done after decreasing the linear velocity.

The processes in the rotational speed adjusting step will now be described. First, in the residual difference detecting step 1301, the residual difference detecting circuit 902 detects the residual difference at the timing of generating acceleration pulse (or deceleration pulse). In the residual difference judging step 1302, the system control circuit 1201 determines whether the detected residual difference is not less than a certain value.

In the case of such a tracking error signal as shown in FIG. 14A, absolute value of the residual difference is larger than a predetermined value (R) at the timing of making track jump (refer to waveform of the track jump pulse indicated by solid line in FIG. 14C). In this case, in the rotational speed adjusting step 1303, the system control circuit 1201 controls the rotational speed changing circuit 1203 to decrease the rotational speed of the spindle motor 3 by a predetermined amount.

Decreasing the rotational speed of the optical disk 1 makes it easier for the actuator to follow the deviation of the tracking position caused by mechanical deformation of the optical disk and, as a result, the residual difference decreases. The operations of steps 1301 through 1303 are repeated so as to decrease the rotational speed till the absolute value of the residual difference becomes less than the value R (refer to FIG. 14A and FIG. 14B).

After decreasing the rotational speed, the residual difference becomes less than the value R as shown in FIG. 14B. By generating the track jump pulse as shown in FIG. 14C under the conditions, track jump can be carried out stably as shown in FIG. 14D.

In this embodiment, as described above, track jump operation is carried out after decreasing the rotational speed (hence the linear velocity) of the disk in case the residual difference of tracking error signal is not less than the predetermined value. This makes it possible to carry out the track jump operation stably over a wide range of linear velocities without adjusting the waveform of the track jump pulse or the position of track jump.

While the amplitudes of acceleration pulse and/or deceleration pulse are adjusted in the first through third embodiments, similar effect can be achieved by adjusting the pulse width in the time domain.

Although the waveform of track jump pulse (acceleration pulse and deceleration pulse) is shown as square waveform, it may be triangular, sinusoidal or other waveform. In practice, it is most preferable to employ square waveform since it is easiest to generate and allows it to easily adjust the pulse width and amplitude.

While parameters (such as amplitude or pulse width) of acceleration pulse and deceleration pulse are adjusted in the first through third embodiments, other parameters of the track jump pulse such as time interval between the acceleration pulse and the deceleration pulse may also be adjusted. Various modifications may be made such as interposing a predetermined period of ground level between the acceleration pulse and the deceleration pulse.

The first through fifth embodiments deal with cases where a single recording/reproducing device handles a single optical disk. In practice, however, a single recording/reproducing device may record and/or reproduce information on and/or from optical disks of different types (CD-ROM, CD-R, CD-RW, CD+R, CD+RW, DVD-ROM, DVD-R, DVD-RW, DVD+R, DVD+RW, DVD-RAM, Blu-ray disk, HD DVD, etc.) of different formats (such as recording density, track pitch and linear velocity). Moreover, even optical disks of the same type may involve different mechanical characteristics (such as surface fluctuation and off-center displacement).

In this case, such measures may be employed as adjusting the waveform of the track jump pulse, adjusting the position of track jump or adjusting the linear velocity individually for each of the plurality of optical disks. It is preferable to apply different methods of adjustment in accordance to different mechanical characteristics or formats of the optical disks, which allows it to make the optimum adjustment for the respective type of optical disk.

The methods described above can be applied to any optical disks as long as the disk is a medium of such a type that a laser spot traces tracks, whether it is read only type, one-time write-over type or rewritable type.

Furthermore, effects similar to those described above can be achieved in personal computer, server or recorder that employs the optical information recording/reproducing method or the optical information recording/reproducing device of the present invention.

As described above, the first optical information recording/reproducing method according to the present invention is the method for recording or reproducing information on or from the optical information recording medium by irradiating the optical information recording medium, driven at one of at least two different linear velocities, with a laser beam, the method comprising the error signal detecting step in which the tracking error signal is generated from laser beam reflected on or transmitted through the medium, the tracking control step in which tracking operation is controlled by using the tracking error signal and the track jump control step where the track jump pulse including acceleration pulse and/or deceleration pulse is generated so as to cause the laser spot to jump to the track on or from which information is to be recorded or reproduced, wherein the track jump control step includes a step of changing the waveform of the track jump pulse depending on the linear velocity.

According to this method, since an optimum track jump pulse can be set in accordance to the linear velocity, it is made possible to make track jump operation stably over a wide range of linear velocities. As a result, stable track jump can be achieved over a wide range of linear velocities by making the waveform of the track jump pulse for a high linear velocity different from that of a low linear velocity, so as to record and reproduce information stably.

The track jump control step preferably includes a step of changing amplitude and/or pulse width of track jump pulse in accordance to the linear velocity, which makes it possible to easily adjust the track jump pulse.

It is preferable that the tracking control step includes a step in which tracking operation is controlled by using the first tracking gain in the case of the first linear velocity and tracking operation is controlled by using the second tracking gain that is higher than the first tracking gain in the case of the second linear velocity that is higher than the first linear velocity, and the track jump control step includes a step in which, when tracking operation is controlled by using the second tracking gain, the amplitude and/or pulse width of the acceleration pulse are made larger and the amplitude and/or pulse width of the deceleration pulse are made smaller than those of the case where tracking operation is controlled by using the first tracking gain. This scheme makes it possible to carry out the track jump operation stably even when the tracking gain is switched.

The second optical information recording/reproducing method according to the present invention is a method for recording or reproducing information on or from the optical information recording medium by irradiating the optical information recording medium with a laser beam, the method comprising the error signal detecting step in which the tracking error signal is generated from the laser beam reflected on or transmitted through the medium, the tracking control step in which tracking operation is controlled by using the tracking error signal, the residual difference of tracking detecting step in which residual difference of the tracking error signal is detected during the tracking control operation and the track jump control step in which the track jump pulse including acceleration pulse and/or deceleration pulse is generated so as to cause the laser spot to jump to the track on or from which information is to be recorded or reproduced, wherein the track jump control step includes a step of changing the waveform of the track jump pulse in accordance to the residual difference of the tracking error signal.

According to this method, since an optimum track jump pulse can be set in accordance to the residual difference, it is made possible to make track jump operation stably over a wide range of linear velocities.

The track jump control step preferably includes a step of changing the amplitude and/or pulse width of the track jump pulse in accordance to the residual difference of the tracking error signal, which makes it possible to easily adjust the track jump pulse.

It is preferable that the residual difference of tracking detecting step includes a step in which the polarity and amount of residual difference of the tracking error signal are detected at the timing of making track jump, and the track jump control step includes a step in which, when the acceleration pulse and the residual difference have the same polarity, the amplitude and/or pulse width of the acceleration pulse are decreased and the amplitude and/or pulse width of the deceleration pulse are increased and, when the acceleration pulse and the residual difference have opposite polarities, the amplitude and/or pulse width of the acceleration pulse are increased and the amplitude and/or pulse width of the deceleration pulse are decreased. This scheme makes it possible to easily determine the waveform of track jump pulse.

The track jump control step preferably includes a step of changing the waveform of the track jump pulse according to the optical information recording medium. In this case, an optimum waveform of the track jump pulse can be set for the type of the optical information recording medium.

The third optical information recording/reproducing method according to the present invention is a method for recording or reproducing information on or from the optical information recording medium by irradiating the optical information recording medium with a laser beam, the method comprising the error signal detecting step in which the tracking error signal is generated from the laser beam reflected on or transmitted through the medium, the tracking control step in which tracking operation is controlled by using the tracking error signal, the residual difference of tracking detecting step in which residual difference of the tracking error signal is detected during the tracking control operation and the track jump control step where the track jump pulse including acceleration pulse and/or deceleration pulse is generated so as to cause the laser spot to jump to the track on or from which information is to be recorded or reproduced, wherein the track jump control step includes a step of generating the track jump pulse at a position where the residual difference of the tracking error signal becomes smaller than a predetermined value in one round of the track.

According to this method, it is made possible to make track jump operation stably over a wide range of linear velocities without adjusting the waveform of the track jump pulse.

The track jump control step preferably includes a step of changing the position of generating the track jump pulse according to the optical information recording medium. In this case, track jump can be stably carried out at a preferable position for the type of the optical information recording medium.

The fourth optical information recording/reproducing method according to the present invention is a method for recording or reproducing information on or from the optical information recording medium by irradiating the optical information recording medium with a laser beam, the method comprising the error signal detecting step in which the tracking error signal is generated from the laser beam reflected on or transmitted through the medium, the tracking control step in which tracking operation is controlled by using the tracking error signal, the residual difference of tracking detecting step in which residual difference of the tracking error signal is detected during the tracking control operation and the track jump control step where the track jump pulse including acceleration pulse and/or deceleration pulse is generated so as to cause the laser spot to jump to the track on or from which information is to be recorded or reproduced, wherein the track jump control step includes the step of making track jump after changing the linear velocity of the optical information recording medium in accordance to the residual difference of the tracking error signal.

According to this method, it is made possible to make track jump operation stably over a wide range of linear velocities without adjusting the waveform of the track jump pulse or the position of track jump.

In the track jump control step, it is preferable, when residual difference of the tracking error signal is larger than a predetermined value, to carry out track jump after decreasing the linear velocity of the optical information recording medium, which makes it possible to carry out track jump stably with a simple constitution.

The track jump control step preferably includes the step of changing the linear velocity in accordance to the optical information recording medium. In this case, the optical information recording medium can be driven at a linear velocity appropriate for track jump operation in accordance to the type of the optical information recording medium or for each optical information recording medium, and the track jump can be stably carried out.

It is preferable that the tracking control step includes the step of controlling the tracking operation by using the first tracking gain and the second tracking gain that is higher than the first tracking gain, and the track jump control step includes the step in which, when the second tracking gain is used in the tracking control, amplitude and/or pulse width of the acceleration pulse are made larger and amplitude and/or pulse width of the deceleration pulse are made smaller than those of the case where the first tracking gain is used in the tracking control. In this case, it is made possible to carry out track jump operation stably even when the tracking gain is switched.

The first optical information recording/reproducing device according to the present invention is an apparatus for recording or reproducing information on and/or from the optical information recording medium by irradiating the optical information recording medium, driven at one of at least two different linear velocities, with a laser beam, the device comprising the error signal detecting circuit which generates the tracking error signal from the laser beam reflected on or transmitted through the medium, the tracking control circuit which controls the tracking operation by using the tracking error signal and the track jump control circuit which generates the track jump pulse including acceleration pulse and/or deceleration pulse so as to cause the laser spot to jump to the track on or from which information is to be recorded or reproduced, wherein the track jump control circuit changes the waveform of the track jump pulse in accordance to the linear velocity.

This apparatus is capable of setting an optimum track jump pulse in accordance to the linear velocity, and therefore it is made possible to make track jump operation stably over a wide range of linear velocities.

The track jump control circuit preferably changes the amplitude and/or pulse width of the track jump pulse in accordance to the linear velocity, which makes it possible to easily adjust the track jump pulse.

It is preferable that the tracking control circuit uses the first tracking gain in tracking control in the case of the first linear velocity and uses the second tracking gain that is higher than the first tracking gain in tracking control in the case of the second linear velocity that is higher than the first linear velocity, and the track jump control circuit makes the amplitude and/or pulse width of the acceleration pulse larger and makes the amplitude and/or pulse width of the deceleration pulse smaller than those of the case where the first tracking gain is used in the tracking control, when the second tracking gain is used in the tracking control. In this case, it is made possible to carry out track jump operation stably even when the tracking gain is switched.

The second optical information recording/reproducing device according to the present invention is an apparatus for recording or reproducing information on and/or from the optical information recording medium by irradiating the optical information recording medium with a laser beam, the device comprising the error signal detecting circuit which generates the tracking error signal from the laser beam reflected on or transmitted through the medium, the tracking control circuit which controls the tracking operation by using the tracking error signal, the residual difference of tracking detecting circuit which detects residual difference of the tracking error signal during the track control operation and the track jump control circuit which generates the track jump pulse including acceleration pulse and/or deceleration pulse so as to cause the laser spot to jump to the track on or from which information is to be recorded or reproduced, wherein the track jump control circuit changes the waveform of the track jump pulse in accordance to the residual difference of the tracking error signal.

Since this device is capable of setting an optimum track jump pulse in accordance to the residual difference, it is made possible to make track jump operation stably over a wide range of linear velocities.

The track jump control circuit preferably changes the amplitude and/or pulse width of the track jump pulse in accordance to the residual difference of the tracking error signal, which makes it possible to easily adjust the track jump pulse.

It is preferable that the residual difference of tracking detecting circuit detects the polarity and amount of the residual difference of the tracking error signal at the timing of making jump track, while the track jump control circuit decreases the amplitude and/or pulse width of the acceleration pulse and increases the amplitude and/or pulse width of the acceleration pulse when the acceleration pulse and the residual pulse have the same polarity, and increases the amplitude and/or pulse width of acceleration pulse and decreases the amplitude and/or pulse width of the deceleration pulse when the acceleration pulse and the residual pulse have the opposite polarities. In this case, waveform of the track jump pulse can be easily determined.

The track jump control circuit preferably changes the waveform of the track jump pulse according to the optical information recording medium. In this case, it is made possible to set the waveform of the track jump pulse that is preferable for the type of the optical information recording medium or for each optical information recording medium.

The third optical information recording/reproducing device according to the present invention is a device for recording and/or reproducing information on and/or from the optical information recording medium by irradiating the optical information recording medium with a laser beam, the device comprising the error signal detecting circuit which generates the tracking error signal from the laser beam reflected on or transmitted through the medium, the tracking control circuit which controls the tracking operation by using the tracking error signal, the residual difference of tracking detecting circuit which detects the residual difference of the tracking error signal during the track control operation and the track jump control circuit which generates the track jump pulse including acceleration pulse and/or deceleration pulse so as to cause the laser spot to jump to the track on or from which information is to be recorded or reproduced, wherein the track jump control circuit generates the track jump pulse at a position where the residual difference of the tracking error signal becomes smaller than a predetermined value in one round of the track.

This apparatus is capable of making track jump stably over a wide range of linear velocities without adjusting the waveform of the track jump pulse.

The track jump control circuit preferably changes the position where the track jump pulse is generated, in accordance to the optical information recording medium. In this case, it is made possible to carry out track jump at a position preferable for the type of the optical information recording medium or for each optical information recording medium.

The fourth optical information recording/reproducing device according to the present invention is a device which records and/or reproduces information on and/or from the optical information recording medium by irradiating the optical information recording medium with a laser beam, the device comprising the error signal detecting circuit which generates the tracking error signal from the laser beam reflected on or transmitted through the medium, the tracking control circuit which controls the tracking operation by using the tracking error signal, the residual difference of tracking detecting circuit which detects the residual difference of the tracking error signal during the track control operation, the track jump control circuit which generates the track jump pulse including acceleration pulse and/or deceleration pulse so as to cause the laser spot to jump to the track on or from which information is to be recorded or reproduced, and the linear velocity changing circuit that changes the linear velocity of the optical information recording medium in accordance to the residual difference of the tracking error signal, wherein the track jump control circuit carries out track jump after the linear velocity of the optical information recording medium has been changed in accordance to the residual difference of the tracking error signal.

This apparatus is capable of making track jump over a wide range of linear velocities stably without adjusting the waveform of the track jump pulse or the position of track jump.

It is preferable that the linear velocity changing circuit decreases the linear velocity of the optical information recording medium when the residual difference of the tracking error signal is larger than the predetermined value, and the track jump control circuit carries out track jump after the linear velocity of the optical information recording medium has been decreased when the residual difference of the tracking error signal is larger than the predetermined value. This scheme makes it possible to carry out track jump stably with a simple constitution.

The linear velocity changing circuit preferably changes the linear velocity during track jump in accordance to the optical information recording medium. In this case, the optical information recording medium can be driven at a liner velocity appropriate for the track jump in accordance to the type of the optical information recording medium or for each optical information recording medium, and therefore track jump can be carried out stably.

It is preferable that the tracking control circuit controls the tracking operation by using at least two different tracking gains, and the track jump control circuit increases the amplitude and/or pulse width of the acceleration pulse and decreases the amplitude and/or pulse width of the deceleration pulse when the tracking gain is high. In this case, track jump operation can be carried out stably even when the tracking gain is switched.

### INDUSTRIAL APPLICABILITY

The optical information recording/reproducing method and the optical information recording/reproducing device of the present invention have the effect of recording and reproducing information stably over wide a range of linear velocities, and are valuable particularly for the control of track jump and other applications.

1-26. (canceled)

27. An optical information recording/reproducing method for recording or reproducing information on or from an optical information recording medium by irradiating the optical information recording medium, driven at one of at least two different linear velocities, with a laser beam, comprising:
an error signal detecting step of generating a tracking error signal from the laser beam reflected on or transmitted through the medium;
a tracking control step in which tracking operation is controlled by using the tracking error signal; and
a track jump control step where the track jump pulse including acceleration pulse and/or deceleration pulse is generated so as to cause the laser spot to jump to the track on or from which information is to be recorded or reproduced,
wherein the tracking control step includes a step of changing the tracking gain in at least two ways in accordance to the linear velocity, and
the track jump control step includes a step of changing the waveform of the track jump pulse in accordance to the tracking gain.

28. The optical information recording/reproducing method according to claim 27, wherein the track jump control step includes a step of changing the amplitude and/or pulse width of the track jump pulse in accordance to the tracking gain.

29. The optical information recording/reproducing method according to claim 28, wherein the tracking control step includes a step in which tracking operation is controlled by using a first tracking gain in the case of a first linear velocity and tracking operation is controlled by using a second tracking gain that is higher than the first tracking gain in the case of a second linear velocity that is higher than the first linear velocity; and
the track jump control step includes a step in which, when tracking is controlled by using the second tracking gain, the amplitude and/or pulse width of the acceleration pulse is made larger and the amplitude and/or pulse width of the deceleration pulse is made smaller than those of the case where tracking is controlled by using the first tracking gain.

30. An optical information recording/reproducing method for recording or reproducing information on or from an optical information recording medium by irradiating the optical information recording medium with a laser beam, comprising:
an error signal detecting step of generating tracking error signal from the laser beam reflected on or transmitted through the medium;
a tracking control step in which tracking is controlled by using the tracking error signal;
a residual difference of tracking detecting step of detecting the residual difference of the tracking error signal during the tracking control operation; and
a track jump control step where the track jump pulse including acceleration pulse and/or deceleration pulse is generated so as to cause the laser spot to jump to the track on or from which information is to be recorded or reproduced, wherein
the track jump control step includes a step of changing the waveform of the track jump pulse in accordance to the residual difference of the tracking error signal.

31. The optical information recording/reproducing method according to claim 30, wherein the track jump control step includes a step of changing the amplitude and/or pulse width of the track jump pulse in accordance to the residual difference of the tracking error signal.

32. The optical information recording/reproducing method according to claim 31, wherein the residual difference of tracking detecting step includes a step of detecting the polarity and amount of residual difference of the tracking error signal at the timing of making track jump; and
the track jump control step includes a step of decreasing the amplitude and/or pulse width of the acceleration pulse and increasing the amplitude and/or pulse width of the deceleration pulse when the acceleration pulse and the residual pulse have the same polarity, and increasing the amplitude and/or pulse width of the acceleration pulse and decreasing the amplitude and/or pulse width of the deceleration pulse when the acceleration pulse and the residual pulse have the opposite polarities.

33. The optical information recording/reproducing method according to claim 27, wherein the track jump control step includes a step of changing the waveform of the track jump pulse in accordance to the optical information recording medium.

34. An optical information recording/reproducing method for recording or reproducing information on or from an optical information recording medium by irradiating the optical information recording medium with a laser beam, comprising:
an error signal detecting step of generating a tracking error signal from the laser beam reflected on or transmitted through the medium;
a tracking control step in which tracking is controlled by using the tracking error signal;
a residual difference of tracking detecting step of detecting the residual difference of the tracking error signal during the tracking control operation; and
a track jump control step where the track jump pulse including acceleration pulse and/or deceleration pulse is generated so as to cause the laser spot to jump to the track on or from which information is to be recorded or played back, wherein
the track jump control step includes a step of generating the track jump pulse at a position where the residual difference of the tracking error signal is smaller than a predetermined value in one round of the track.

35. The optical information recording/reproducing method according to claim 34, wherein the track jump control step includes a step of changing the position where the track jump pulse is generated in accordance to the optical information recording medium.

36. An optical information recording/reproducing method for recording or reproducing information on or from an optical information recording medium by irradiating the optical information recording medium with a laser beam, comprising:
an error signal detecting step of generating a tracking error signal from the laser beam reflected on or transmitted through the medium;
a tracking control step in which tracking is controlled by using the tracking error signal;
a residual difference of tracking detecting step of detecting the residual difference of the tracking error signal during the tracking control operation; and
a track jump control step where the track jump pulse including acceleration pulse and/or deceleration pulse is generated so as to cause the laser spot to jump to the track on or from which information is to be recorded or played back, wherein
the track jump control step includes a step of carrying out track jump after changing the linear velocity of the optical information recording medium in accordance to the residual difference of the tracking error signal.

37. The optical information recording/reproducing method according to claim 36, wherein the track jump control step includes a step of carrying out track jump after decreasing the linear velocity of the optical information recording medium when the residual difference of the tracking error signal is larger than a predetermined value.

38. The optical information recording/reproducing method according to claim 36, wherein the track jump control step includes a step of changing the linear velocity for making track jump in accordance to the optical information recording medium.

39. The optical information recording/reproducing method according to claim 30, wherein the tracking control step includes a step of using a first tracking gain and a second tracking gain which is higher than the first tracking gain; and
the track jump control step includes a step in which, when the tracking is controlled by using the second tracking gain, amplitude and/or pulse width of the acceleration pulse is made larger and amplitude and/or pulse width of the deceleration pulse is made smaller than those in the case of tracking control by using the first tracking gain.

40. An optical information recording/reproducing device for recording or reproducing information on and/or from the optical information recording medium by irradiating the optical information recording medium, driven at one of at least two different linear velocities, with a laser beam, comprising:
an error signal detecting circuit which generates a tracking error signal from the laser beam reflected on or transmitted through the medium;
a tracking control circuit which controls the tracking operation by using the tracking error signal; and
a track jump control circuit which generates the track jump pulse including acceleration pulse and/or deceleration pulse so as to cause the laser spot to jump to the track on or from which information is to be recorded or reproduced,
wherein the tracking control circuit changes the tracking gain in at least two ways in accordance to the linear velocity, and
the track jump control circuit changes the waveform of the track jump pulse in accordance to the tracking gain.

41. The optical information recording/reproducing device according to claim 40, wherein the track jump control circuit changes the amplitude and/or pulse width of the track jump pulse in accordance to the tracking gain.

42. The optical information recording/reproducing device according to claim 41, wherein the tracking control circuit controls tracking by using the first tracking gain in the case of the first linear velocity and controls tracking by using the second tracking gain that is higher than the first tracking gain in the case of the second linear velocity that is higher than the first linear velocity; and
the track jump control circuit makes the amplitude and/or pulse width of the acceleration pulse larger and makes the amplitude and/or pulse width of the deceleration pulse smaller than those of the case where tracking is controlled by using the first tracking gain, when tracking is controlled by using the second tracking gain.

43. An optical information recording/reproducing device for recording or reproducing information on and/or from an optical information recording medium by irradiating the optical information recording medium with a laser beam, comprising:
an error signal detecting circuit which generates a tracking error signal from the laser beam reflected on or transmitted through the medium;
a tracking control circuit which controls the tracking operation by using the tracking error signal;
a residual difference of tracking detecting circuit which detects the residual difference of the tracking error signal during the track control operation; and
a track jump control circuit which generates the track jump pulse including acceleration pulse and/or deceleration pulse so as to cause the laser spot to jump to the track on or from which information is to be recorded or played back, wherein
the track jump control circuit changes the waveform of the track jump pulse in accordance to the residual difference of the tracking error signal.

44. The optical information recording/reproducing device according to claim 43, wherein the track jump control circuit changes the amplitude and/or pulse width of the track jump pulse in accordance to the residual difference of the tracking error signal.

45. The optical information recording/reproducing device according to claim 44, wherein
the residual difference of tracking detecting circuit detects the polarity and amount of the residual difference of the tracking error signal at the timing of making track jump; and
the track jump control circuit decreases the amplitude and/or pulse width of the acceleration pulse and increases the amplitude and/or pulse width of the deceleration pulse when the acceleration pulse and the residual pulse have the same polarity, and increases the amplitude and/or pulse width of the acceleration pulse and decreases the amplitude and/or pulse width of the deceleration pulse when the acceleration pulse and the residual pulse have the opposite polarities.

46. The optical information recording/reproducing device according to claim 40, wherein the track jump control circuit changes the waveform of the track jump pulse in accordance to the optical information recording medium.

47. An optical information recording/reproducing device for recording or reproducing information on and/or from the optical information recording medium by irradiating the optical information recording medium with a laser beam, comprising:
an error signal detecting circuit which generates the tracking error signal from the laser beam reflected on or transmitted through the medium;
a tracking control circuit which controls the tracking operation by using the tracking error signal;
a residual difference of tracking detecting circuit which detects the amount of residual difference of the tracking error signal during the tracking control operation; and
a track jump control circuit which generates the track jump pulse including acceleration pulse and/or deceleration pulse so as to cause the laser spot to jump to the track on or from which information is to be recorded or reproduced, wherein
the track jump control circuit generates the track jump pulse at a position where the residual difference of the tracking error signal becomes smaller than a predetermined value in one round of the track.

48. The optical information recording/reproducing device according to claim 47, wherein the track jump control circuit changes the position where the track jump pulse is generated in accordance to the optical information recording medium.

49. An optical information recording/reproducing device for recording or reproducing information on and/or from an optical information recording medium by irradiating the optical information recording medium with a laser beam, comprising:
an error signal detecting circuit which generates a tracking error signal from the laser beam reflected on or transmitted through the medium;
a tracking control circuit which controls the tracking operation by using the tracking error signal;
a residual difference of tracking detecting circuit which detects the residual difference of the tracking error signal during the track control operation;
a track jump control circuit which generates the track jump pulse including acceleration pulse and/or deceleration pulse so as to cause the laser spot to jump to the track on or from which information is to be recorded or played back; and
a linear velocity changing circuit which changes the linear velocity of the optical information recording medium in accordance to the residual difference of the tracking error signal, wherein
the track jump control circuit carries out track jump after the linear velocity of the optical information recording medium has been changed in accordance to the residual difference of the tracking error signal.

50. The optical information recording/reproducing device according to claim 49, wherein
the linear velocity changing circuit decreases the linear velocity of the optical information recording medium when the residual difference of the tracking error signal is larger than a predetermined value; and
the track jump control circuit carries out track jump after the linear velocity of the optical information recording medium has been decreased in case the residual difference of the tracking error signal is larger than the predetermined value.

51. The optical information recording/reproducing device according to claim 49, wherein the linear velocity changing circuit changes the linear velocity at which track jump is carried out in accordance to the optical information recording medium.

52. The optical information recording/reproducing device according to claim 43, wherein
the tracking control circuit controls tracking by using the first tracking gain and the second tracking gain that is higher than the first tracking gain; and
the track jump control circuit makes the amplitude and/or pulse width of the acceleration pulse larger and makes the amplitude and/or pulse width of the deceleration pulse smaller than those of the case where tracking is controlled by using the first tracking gain, when tracking is controlled by using the second tracking gain.
